(19) United States
(12) Patent Application Publication
(10) Pub. No.: US 2013/0209032 A1
(43) Pub. Date: Aug. 15, 2013

(54) Free Optical Beam Fiber-to-Fiber Coupling Systems

(71) Applicant: Trumpf Laser GmbH + Co. KG, (US)

(72) Inventors: Klaus Wallmeroth, Zimmern o.R. (DE); Philipp Wagenblast, Villingen-Schwenningen (DE); Stefan Fuchs, Boehringen (DE); Christoph Tillkorn, Villingendorf (DE)

(73) Assignee: TRUMPF LASER GMBH + CO. KG, Schramberg (DE)

(21) Appl. No.: 13/766,392

(22) Filed: Feb. 13, 2013

(30) Foreign Application Priority Data
Feb. 14, 2012 (DE) 102012202177.9

(51) Int. Cl. G02B 6/26; G02B 6/42; G02B 6/32

(52) U.S. Cl. CPC G02B 6/262; G02B 6/32; G02B 6/4296
USPC 385/24

(57) ABSTRACT

A fiber-to-fiber coupling system includes: multiple optical input fibers, each optical input fiber having an exit-face on a light-exit side of the optical input fiber, in which the light-exit-sides are disposed around a central axis, and in which an optical axis extending through the light-exit side is tilted toward the central axis; an optical output fiber having an entry-face for receiving light; and an optical input-coupling device arranged to couple a light beam exiting from the end-face of each optical input fiber into the entry-face of the output fiber. The optical input-coupling device comprises, for each light beam exiting the exit surfaces of the optical input fibers, a single corresponding lens to transmit the light beam or a single corresponding ellipsoidal mirror to reflect the light beam.

### CROSS REFERENCE TO RELATED APPLICATION

This application claims priority under 35 U.S.C. §119(a) to German Application No. 10 2012 202 177.9, filed on Feb. 14, 2012, the entire contents of which are hereby incorporated by reference.

### BACKGROUND

Fiber-to-fiber coupling devices for laser radiation are known in which the light-exit side fiber ends of multiple input fibers are disposed in parallel relationship around a central axis. The laser beams exiting the input fibers are each concentrated via a separate respective collecting lens and then focused into an output fiber through a common input-coupling lens (“2-lens concept, 4f-imaging”), whereby the power in the output fiber is increased by the factor n. In the case of n input fibers, the optical free beam fiber-to-fiber coupler requires in total (n+1) lenses. Thus, in order to meet the 4f condition, the coupler may require a large number of optical components resulting in a great overall length. Furthermore, inhomogeneous illumination of the input-coupling lens, for example due to differing degrees of heating of the collecting lenses, may result in an inhomogeneous thermo-optical focus shift of the fiber-to-fiber coupler.

For combining beams from high-power fiber lasers, fiber-optically integrated beam combiners (tapered fiber bundles) may be used, such as, for example, the beam combiners described in EP 2 071 376. In that case, multiple input fibers are combined by a fixed connection to form one output fiber and, for stability, a capillary tube is used. That form of beam combination has the disadvantage that it involves losses, since it is difficult from the point of view of production engineering to maintain high-quality guiding properties of the fundamental-mode fibers in the transition region. In addition, the losses occur in a very small volume, resulting in high temperature stresses in the beam combiner.

### SUMMARY

The present disclosure relates to free optical beam fiber-to-fiber coupling systems. In general, in a first aspect, the subject matter of the present disclosure can be embodied in a free optical beam fiber-to-fiber coupling system that includes: multiple optical input fibers whose light-exit-side fiber ends are disposed around a central axis; an optical output fiber; and an optical input-coupling device which couples light beams exiting the end-face exit surfaces of the input fibers into the end-face entry surface of the light-entry-side of the output fiber.

The light-exit side ends of multiple optical input fibers are disposed with their optical axes each tilted in the direction towards a central axis, in which each light beam exiting the input fibers is transmitted by a respective imaging lens or reflected by a respective ellipsoidal mirror. Each of the light-exit-side fiber ends is oriented with its optical axes towards the same point of the central axis.

The fiber-to-fiber coupling system can, in certain implementations, reduce or prevent the thermo-optical focus shift of prior systems and also exhibit an improvement in consistency of performance.

The optical free beam coupling system images from one to n input fibers directly onto the output fiber. The imaging ratio of the coupling system represents a compromise between efficiency in fiber coupling and maintaining the beam quality. The beam may be imaged onto the output fiber using both transmission through a lens and reflectance from a mirror. The basis for calculation of the focal length f of the optical input-coupling device is the imaging equation 1/f=1/g+1/b where g corresponds to the distance of the input fiber from the optical input-coupling system and b corresponds to the distance of the input fiber from the output fiber. The imaging ratio is then given by the quotient b/g. When geometrically superpositioning multiple input fibers for the purpose of scaling power into the multi-kW range, an important criterion for maintaining beam quality is the optimization of the fill factor or packing density at the site of the optical input-coupling device. This provides, depending on the number of input fibers, the following possible arrangements: triangular arrangement of three input fibers, square arrangement of four input fibers, etc.

Because a single lens or a single mirror is used per input fiber, the coupling system is, in certain implementations, capable of coupling high-power laser radiation in the multi-kW range, is very compact, and is focus-shift-optimized relative to coupling systems using the 2-lens concept. The coupling system also simplifies service and replacement due to reduced development costs and lower risks of failure.

When ellipsoidal mirrors are used in the optical input-coupling device, the multiple ellipsoidal mirror regions may either be of a monolithic construction made of metal, especially copper, or of glass. Alternatively, the ellipsoidal mirrors may be assembled from multiple parts.

To safeguard the long-term optical stability, the optical input-coupling device and/or the holders of the input and output fibers are, in some implementations, temperature-regulated. That is, the optical input-coupling device and/or the holders are kept at constant temperature. Additionally, the optical input-coupling device and/or the holders of the input and output fibers may have adjusting accuracies in the micrometer range so that reproducible beam paths for the light beams between the input and output fibers can be obtained.

In some implementations, the tilt angle of the optical axes of the light-exit-side fiber ends of the optical input fibers are arranged relative to the central axis from approximately 20 to approximately 150 mrad.

Further advantages will be apparent from the claims, the description, and the drawings. The features mentioned above and the features set forth hereinafter may also be used individually or may be used in any desired combination. The illustrative embodiments shown and described are not to be understood as forming a definitive list, but rather are of the nature of examples for illustrating the invention.

### DESCRIPTION OF DRAWINGS

FIG. 1 is a schematic that illustrates a fiber-to-fiber coupling system, with a transmissive optical coupling device for direct imaging of three input fibers onto one output fiber.

FIG. 2 is a schematic that illustrates a fiber-to-fiber coupling system, with a reflective optical coupling device for direct imaging of three input fibers onto one output fiber.

FIG. 3 is a schematic that illustrates a beam path for direct imaging of one of the input fibers shown in FIG. 2 onto the output fiber.

### DETAILED DESCRIPTION

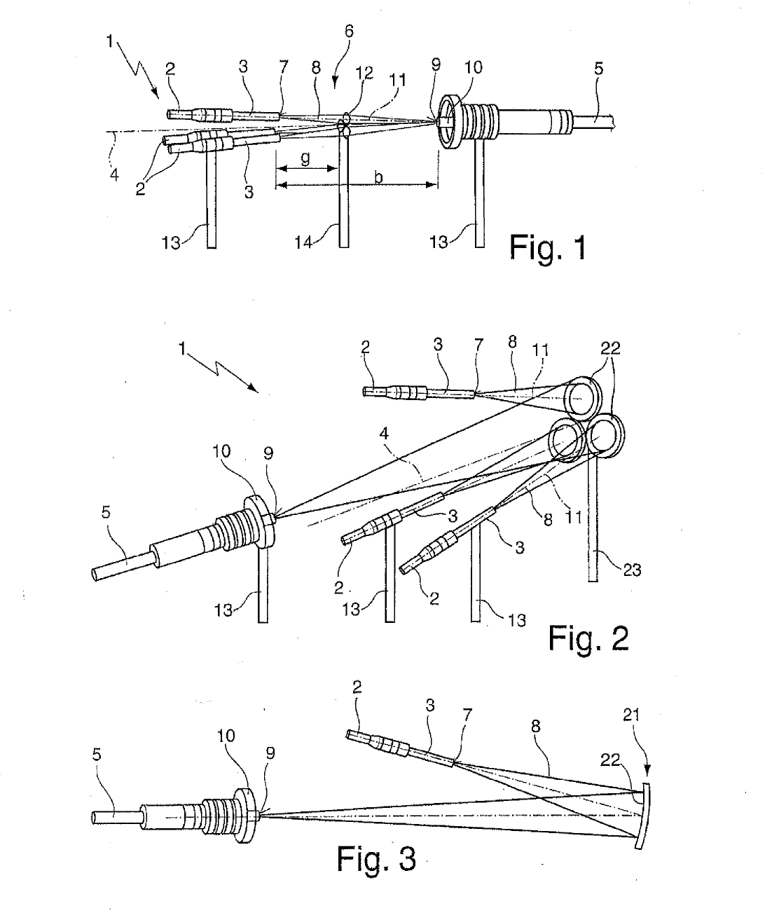

The coupling system 1 shown in FIG. 1 is a high-power-capable, optical free beam fiber-to-fiber coupler having multiple (n) optical input fibers 2 (e.g., three optical input fibers as shown in FIG. 1), whose light-exit-side fiber ends 3 are disposed around a central axis 4. The coupling system 1 further includes an optical output fiber 5 and an optical input-coupling device 6, which couples the light beams 8 exiting end-face exit surfaces 7 of the input fibers 2 into an end-face entry surface 9 of a light-entry-side fiber end 10 of the output fiber 5. The power in the output fiber 5 is thereby increased by the factor n.

The light-exit-side fiber ends 3 are oriented with their optical axes 11 each tilted in the direction towards the central axis 4, and more specifically are all oriented towards the same point of the central axis 4. The light-exit-side fiber ends 3 are disposed around the central axis 4 angularly symmetrically. That is, the light-exit-side fiber ends 3 are disposed at substantially identical angular distances (i.e., rotationally symmetric, e.g., 120° apart in the case of three fibers, and 90° apart in the case of four fibers), and at a same radius from the central axis 4. The light-exit-side fiber ends 3 also can be disposed at different distances from the central axis, but the requirement that all fiber ends 3 are oriented towards the same point of the central axis 4 continues to apply.

The optical input-coupling device 6 includes three single lenses 12 disposed around the central axis 4 that are transmissive to the laser beam 8 so as to project the laser beams 8 exiting the exit surfaces 7 of the input fibers 2 directly onto the entry surface 9 of the output fiber 5. The imaging ratio is in this case a compromise between efficiency in fiber coupling and maintaining the beam quality. The basis for calculation of the focal length f of the single lenses 12 is the imaging equation 1/f=1/g+1/b where g corresponds to the distance of the exit surface 7 from the lenses 12 and b corresponds to the distance of the exit surface 7 from the entry surface 9. The imaging ratio is then given by the quotient b/g. For the geometric superposition of multiple input fibers 2 for power scaling into the multi-kW range, optimization of the fill factor or packing density at the site of the lenses 12 is an important criterion for maintaining beam quality. Depending on the number (n) of input fibers 2, this provides the following possible arrangements: triangular arrangement of three input fibers 2, square arrangement of four input fibers 2, etc. Preferably, an arrangement of the densest circle packing (when n=3, 7, 19 . . . ) is chosen.

The fiber ends 3, 10 are configured as standard fiber plugs and are fastened in holders 13 with corresponding sockets. The lenses 12 are also fastened by way of a holder 14. The holders 13, 14 have adjusting accuracies in the micrometer range and are temperature-regulated in order to safeguard the entire structure with regard to long-term optical stability. By virtue of the use of a single-lens imaging system 12, the coupling system 1 is, in certain implementations, very compact and also optimized in terms of thermal focus shift and aberrations in comparison with previously known 2-lens concept in 4f-imaging.

The fiber-to-fiber coupling system 1 shown in FIGS. 2 and 3 differs from the coupling device of FIG. 1 in that the optical input-coupling device 6 is formed using three ellipsoidal mirrors 22 for each of the laser beams 8 exiting the exit surfaces 7 of the input fibers 2. The multiple ellipsoidal mirrors 22 may either be of a monolithic construction made of, for example, metal (e.g., copper), or of glass, or may be multi-part and assembled from individual ellipsoidal mirrors. The ellipsoidal mirrors 22 are fastened by way of a holder 23. The holders 13, 23 have adjusting accuracies in the micrometer range and are temperature-regulated in order to safeguard the entire structure with regard to long-term optical stability. By imaging with only one ellipsoidal mirror 22 for each beam 8, the coupling system 1 is very compact and simplifies servicing and/or replacement of components. In addition, with reflective imaging using the ellipsoidal mirrors 22, there is no optical focus shift.

Example ranges of values for the fiber-to-fiber coupling system 1 are as follows: the fiber-to-fiber coupling system 1 can have an imaging ratio from about 0.75 to about 4; the focal length of optical input-coupling device 6 can be from about 30 mm to about 500 mm; the aperture of light-exit-side fiber ends 3 can have a diameter from about 3 mm to about 25 mm; the tilt angle can be from about 20 mrad to 150 mrad; the divergence of the input beams 8 exiting the exit surfaces 7 of the input fibers 2 can be from about 30 mrad to about 200 mrad; the beam diameter on the input side of optical input-coupling device 6 can be from about 10 μm to about 40 μm; the beam diameter on the output side of optical input-coupling device 6 can be from about 30 μm to about 1000 μm; the beam quality from the input side can be from about 0.3 mm×mrad to about 3 mm×mrad; and the beam quality from the output side can be from about 2 mm×mrad to about 20 mm×mrad.

A number of embodiments have been described. Nevertheless, it will be understood that various modifications may be made without departing from the spirit and scope of the invention. Accordingly, other embodiments are within the scope of the following claims.

What is claimed is:

1. A fiber-to-fiber coupling system comprising:
a plurality of optical input fibers, each optical input fiber having an exit-face on a light-exit side of the optical input fiber, wherein the light-exit-sides are disposed around a central axis, and wherein an optical axis extending through the light-exit side is tilted toward the central axis;
an optical output fiber having an entry-face for receiving light; and
an optical input-coupling device arranged to couple a light beam exiting from the end-face of each optical input fiber into the entry-face of the output fiber,
wherein the optical input-coupling device comprises, for each light beam exiting the exit surfaces of the optical input fibers, a single corresponding lens to transmit the light beam or a single corresponding ellipsoidal mirror to reflect the light beam.

2. A fiber-to-fiber coupling system according to claim 1, wherein the optical input-coupling device comprises the ellipsoidal mirrors, and wherein each ellipsoidal mirror is a monolithic composition of a single material.

3. A fiber-to-fiber coupling system according to claim 1, wherein the optical input-coupling device comprises the ellipsoidal mirrors, and wherein each ellipsoidal mirror is composed of a plurality of separate parts assembled together.

4. A fiber-to-fiber coupling system according to claim 1, wherein the optical input-coupling device comprises the ellipsoidal mirrors, and wherein each ellipsoidal mirror is composed of metal or glass.

5. A fiber-to-fiber coupling system according to claim 1, wherein the light-exit-side of each optical input fiber is disposed around the central axis at a same angular distance.

6. A fiber-to-fiber coupling system according to claim 1, wherein the light-exit-sides of the optical input fibers are symmetrically disposed around the central axis.

7. A fiber-to-fiber coupling system according to claim 1, wherein the light-exit-sides of the optical input fibers are disposed around the central axis at a same radius.

8. A fiber-to-fiber coupling system according to claim 1, wherein the optical axis of each light-exit-side is oriented toward a same point on the central axis.

9. A fiber-to-fiber coupling system according to claim 1, wherein the light-exit-sides of the optical input fibers and a light-entry-side of the optical output fiber are held in holders.

10. A fiber-to-fiber coupling system according to claim 9, wherein the holders comprise a plug and socket connection.

11. A fiber-to-fiber coupling system according to claim 9, wherein the optical input-coupling device and/or the holders are temperature-regulated.

12. A fiber-to-fiber coupling system according to claim 1, wherein the fiber-to-fiber coupling system is configured to guide laser radiation having an aggregate power in the multi-kW range.

13. A fiber-to-fiber coupling system according to claim 1, wherein a tilt angle between each optical axis and the central axis is between approximately 20 mrad to approximately 150 mrad.
